(19) United States
(12) Patent Application Publication
(10) Pub. No.: US 2017/0091793 A1
(43) Pub. Date: Mar. 30, 2017

(54) SOCIAL MEDIA DRIVEN EVALUATION OF A PRODUCT IDEA

(71) Applicant: Jazwares, LLC, Sunrise, FL (US)

(72) Inventors: Judd Zebersky, Weston, FL (US); Sophie Lefebvre, Miami Beach, FL (US)

(21) Appl. No.: 14/871,722

(22) Filed: Sep. 30, 2015

(51) Int. Cl. G06Q 30/02; G06Q 50/00

(52) U.S. Cl. CPC G06Q 30/0203; G06Q 50/01

(57) ABSTRACT

A method, system and computer program product for social media driven evaluation of a product idea is provided. The method includes providing access to social media Web site to different members and distributing to requesting ones of the different members, a submission form that includes different text input fields receiving descriptive text regarding a product idea. A completed form is then received from each of the requesting members with descriptive text for respectively different product ideas, a record is stored for each product idea and a list generated based upon each stored record. Finally, the method list is displayed in the Web site, votes are received from a selection of the different members for each of the product ideas in the list and only a selection of product ideas receiving a threshold number of votes over a fixed period of time are submitting to a crowd sourced funding engine of the Web site.

### BACKGROUND OF THE INVENTION

Field of the Invention

The present invention relates to automated product idea evaluation and more particularly to social media evaluation of a product idea.

Description of the Related Art

Traditionally, product ideas are evaluated amongst only a small group of individuals in consequence of which, a decision is made to construct a prototype and to raise capital so as to launch the proposed product into the consumer marketplace. This form of entrepreneurship requires on the part of the organizer, patience, luck and multiple different relationships between the organizer and key vendors, including engineers, manufacturers, marketing professionals, sales professionals, attorneys and accountants. Identifying a source of capital to fund the development and production of the product idea only compounds matters.

The advent of the global Internet has dramatically facilitated the process of product development and product in several ways. First, product ideas now can be vetted by large numbers of globally dispersed individuals so as to identify flaws and strengths with respect to the product idea. More importantly, the need for long-standing relationships with different key vendors has been supplanted by access to a simple online directory of service providers. Most importantly, access to capital has been greatly simplified by the social media oriented crowd-funding mechanism.

Crowd funding is the practice of funding a project or venture by raising many small amounts of money from a large number of people, typically via the Internet. Different Web sites facilitate each crowd funding transaction by providing a facility through which different product ideas can be described and accessed by end users visiting the Web site, and through which funds can be collected by the Web site and distributed to the organizer seeking to bring a product based upon the product idea to market. The most popular crowd funding sites provide not only for direct equity investments by different end users, but also institutional debt financing. At least one crowd funding Web site provides for gifting of contributions rather than equity or debt investment contributions.

Crowd funding alone, however, does not solve the larger problem coordinating the process of bringing a product idea to life. Indeed there are services that, for a fee, will generate a template business plan and perhaps also prepare a patent application on behalf of an inventor. But, none allow for the determination of the viability of a product idea, the funding of the implementation of the product idea and the facilitation of the design, manufacture, branding and distribution of a product based upon the product idea. Accordingly, the entrepreneur lacking substantial know-how and resources remains disadvantaged.

### BRIEF SUMMARY OF THE INVENTION

Embodiments of the present invention address deficiencies of the art in respect to product idea evaluation and provide a novel and non-obvious method, system and computer program product for social media driven evaluation of a product idea. In an embodiment of the invention, a method for social media driven evaluation of a product idea includes providing access to social media Web site served by a Web server over a computer communications network to different members of the social media Web site. The method further includes distributing from the Web server over the computer communications network to requesting ones of the different members, a submission form of the social media Web site that includes different text input fields receiving descriptive text regarding a product idea. The method yet further includes receiving from each of the requesting ones of the members in the Web site, a completed form with descriptive text for respectively different product ideas, storing a record in a database coupled to the Web server for each of the different product ideas and generating a list of the product ideas based upon each stored record. Finally, the method includes displaying the list in the social media Web site for viewing by the different members, receiving from a selection of the different members a multiplicity of votes for each of the product ideas in the list and submitting to a crowd sourced funding engine of the Web site only ones of the product ideas receiving a threshold number of votes over a fixed period of time.

In one aspect of the embodiment, each vote is a rating and a score is computed for each of the different product ideas as a sum of ratings for received votes such that only ones of the product ideas receiving a threshold score over a fixed period of time are submitted to the crowd sourced funding engine of the Web site. In another aspect of the embodiment, each vote received for a corresponding one of the product ideas is weighted inversely in relationship to a lapse of time between when each vote is received and when a corresponding one of the forms for a corresponding one of the product ideas is submitted to the Web site. In yet another aspect of the embodiment, each vote received for a corresponding one of the product ideas is weighted in respect to a recorded reputation of a corresponding one of the selection of the different members providing the received vote. For instance, the recorded reputation may be a value computed based upon a number of votes previously cast by the corresponding one of the selection of the different members for others of the product ideas. Alternatively, the recorded reputation may be a value computed based upon a number of votes previously cast by the corresponding one of the selection of the different members for others of the product ideas submitted to the crowd sourced funding engine of the Web site.

In another embodiment of the invention, a social media data processing system is configured for social media driven evaluation of a product idea. The system includes a host computing system having one or more computers each with memory and at least one processor. The system also includes a Web server executing in the host computing system and serving different Web pages defining a social media Web site for access by different members. In this regard, the Web site includes at least one submission form for service to requesting ones of the members of the social media Web site that specifies a product idea through different text input fields receiving descriptive text regarding a product idea. Yet further, the system includes a crowd sourced funding engine executing in the host computing system and being accessible through the Web site.

Of note, the system even yet further includes a product idea evaluation module coupled to the Web server. The module includes program code enabled upon execution in the host computing system to process completed submission forms respectively including descriptive text for correspondingly different product ideas, to store a record in a database of the host computing system for each of the different product ideas and to generate a list of the different product ideas based upon each stored record, to direct a display by the Web server of the list in the social media Web site for viewing by the different members, to receive from a selection of the different members a multiplicity of votes for each of the product ideas in the list and to submit to the crowd sourced funding engine only ones of the product ideas receiving a threshold number of votes over a fixed period of time.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for social media driven evaluation of a product idea;

FIG. 2 is a schematic illustration of a social media data processing system configured for social media driven evaluation of a product idea; and,

FIGS. 3A and 3B, taken together, is a flow chart illustrating a process for social media driven evaluation of a product idea.

### DETAILED DESCRIPTION OF THE INVENTION

Embodiments of the invention provide for social media driven evaluation of a product idea. In accordance with an embodiment of the invention, different product ideas are received by way of a submission form of a social media Web site presented by a Web server and received as a response to the submission form. Once submitted, each product idea is presented in the Web site to different members of the Web site in a list of other product ideas and the different members vote for each of the product ideas. Product ideas receiving a threshold number of votes over a fixed period of time are filtered from product ideas failing to receive a threshold number of votes over the fixed period of time. Those product ideas receiving the threshold number of votes, optionally are screened manually, and those passing manual screening are then submitted to a crowd sourced funding portion of the Web site or a crowd sourced funding portion of an external Web site, whereas product ideas failing to reach a threshold number of votes are excluded from participation in crowd sourced funding. In this way, only those products socially determined to be most promising are subjected to automated crowd sourced fundraising.

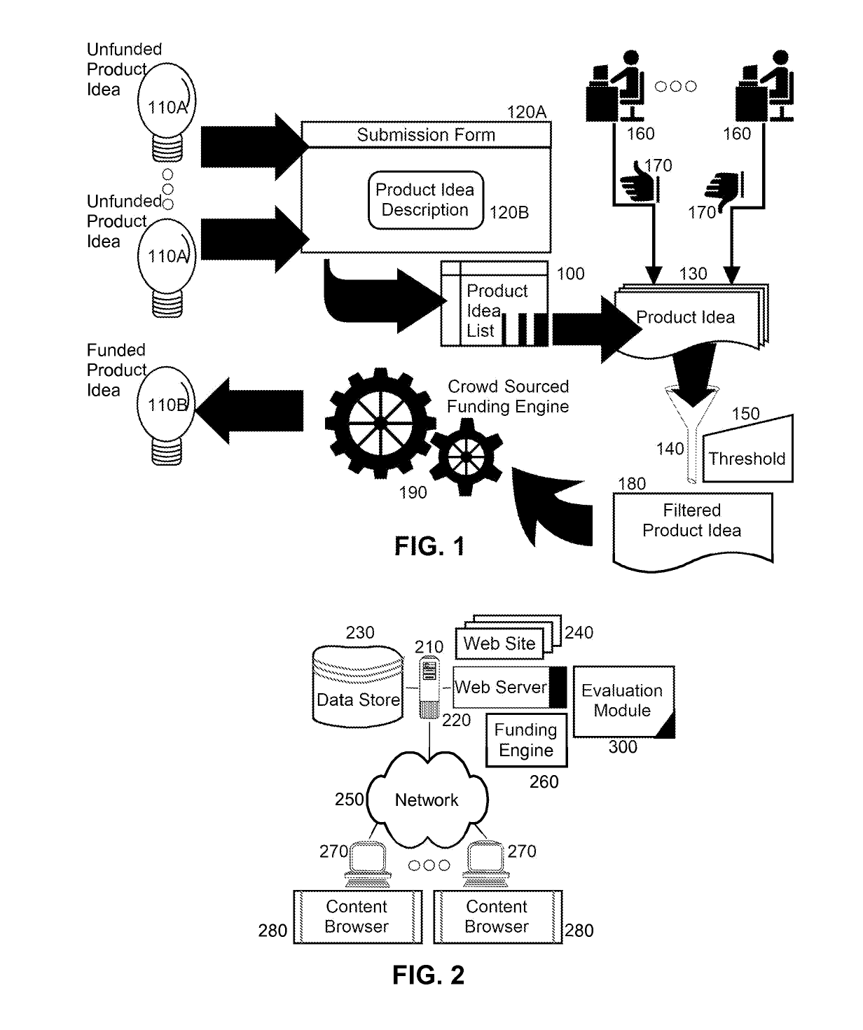

In further illustration, FIG. 1 pictorially shows a process for social media driven evaluation of a product idea. As shown in FIG. 1A, different unfunded product ideas 110A are submitted to a social media Web site by way of a submission form 120A included as part of the social media Web site. The submission form 120A provides a selection of user interface controls including textual input fields in which a description 120B of the unfunded product idea 110A is defined. In response to the completion of the submission form 120A, a record 130 is created for the unfunded product idea 110A and the record 130 is included in a list 100 of other unfunded product ideas 110A.

Thereafter, different members 160 of the social media Web site view the product idea list 100 and in particular, different ones of the product idea records 130. Each of the different members 160 may then apply a vote 170 for a corresponding one or more of the unfunded product ideas 110A reflected in corresponding product idea records 130. The vote 170 may be a simple “Yes”, a “Yes” or “No”, or in a more complex embodiment, the vote may be a numerical rating of degrees of approval, or a range from disapproval to approval such that the vote 170 is a weighted vote. In an even further complex embodiment, the vote 170 may be weighted in an inverse relationship to the time that has elapsed at the time of the vote 170 from the time when the product idea record 130 for the unfunded product idea 110A was first submitted. In an even yet further complex embodiment, the vote 170 may be weighted in relationship to the number of votes previously cast by the different member 160 casting the vote 170, or alternatively, the vote 170 may be weighted in relationship to the number of votes previously cast by the different member 160 for unfunded product ideas 110A subsequently submitted to a crowd sourced funding engine 190 of the social media Web site.

In this regard, periodically, the product idea records 130 can be subjected to a filter 140 based upon a threshold value 150 such that ones of the product idea records 130 which have received a number of votes 170 beyond the threshold value 150 are considered to be fundable product ideas. To the extent that the votes 170 are weighted, a sum of the weighted votes 170 is compared to the threshold value 150 when subjected to the filter 140. In either case, thereafter the filtered product ideas 180 are screened manually by one or more individuals, with the remaining ones of the filtered product ideas 180 being submitted to the crowd sourced funding engine 190 of the social media Web site (or of a communicatively coupled social media Web site). Consequently, the fundable product ideas 180 thereafter may become funded product ideas 110B in a way such that only those of the unfunded product ideas 110A which are considered by the members 160 of the social media Web site compete for funding through the crowd sourced funding engine 190.

The process described in connection with FIG. 1 is implemented in a social media data processing system. In yet further illustration, FIG. 2 schematically shows a social media data processing system configured for social media driven evaluation of a product idea. The system includes a host computing system 210 that includes one or more computers, each with memory and at least one processor. A Web server 220 executes in the host computing system 210 and provides access to different end users to a Web site 240 served page by page over computer communications network 250 for display in respectively different content browsers 280 operable in different client computers 270 communicatively coupled to the host computing system 210.

The Web site 240 can include different pages acting as an interface to program logic of both a crowd sourced funding engine 260 and a product idea evaluation module 300, as well as data stored in data store 230. The crowd sourced funding engine 260 includes program code that when executes in the memory of the host computing system 210 provides a socially interactive collection of Web pages permitting different members of the social media Web site 240 to pledge financial support for a selected product idea. Indeed, the program code includes transactional logic configured to facilitate financial transactions from the members in funding a selected product idea.

The product idea evaluation module 300 also includes program code that executes in the memory of the host computing system 210. The program code is enabled to receive through the submission of a form, a description of an unfunded product idea. The program code also is enabled to include the information regarding the unfunded product idea in a list of product ideas and to present the list to different members of the social media Web site 240. The program code further is enabled to receive votes from the different members in respect to a selected one of the product ideas and to determine whether or not one or more of the product ideas has received a threshold number of votes or a threshold score derived from a sum of the weighting of the votes. Finally, the program code is enabled to submit to the crowd sourced funding engine 260 those of the product ideas that have received a threshold number of votes or a threshold score derived from a sum of the weighting of the votes.

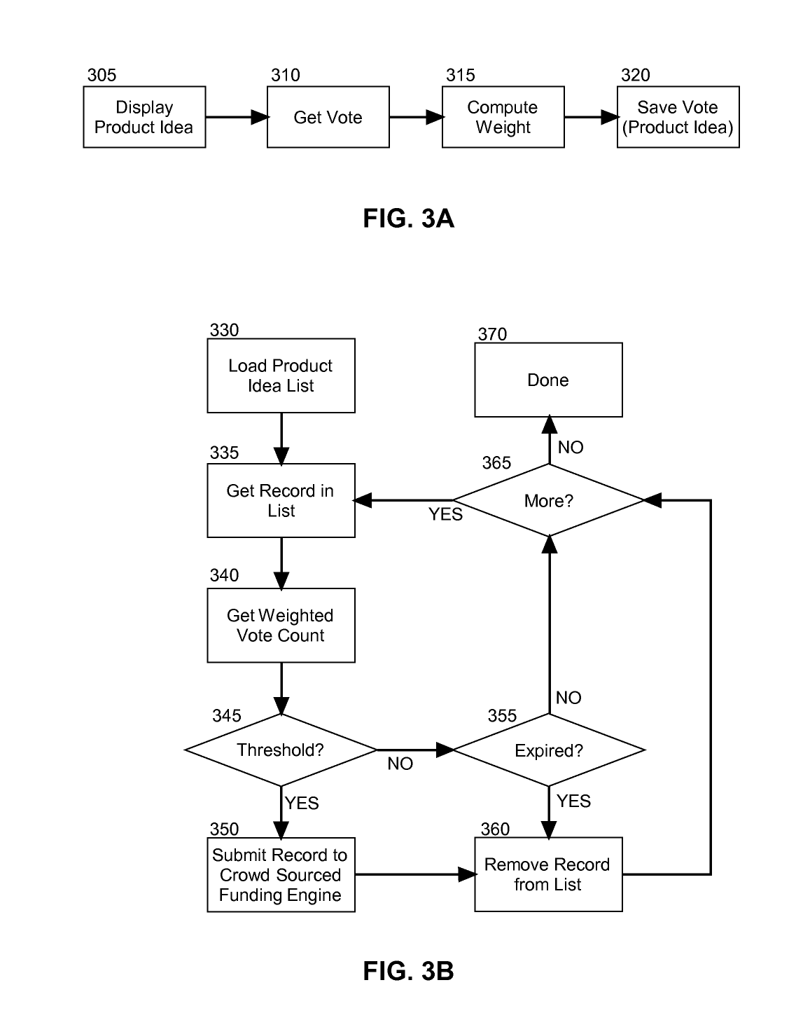

In even yet further illustration of the operation of the product idea evaluation module 300, FIGS. 3A and 3B, taken together, are a flow chart illustrating a process for social media driven evaluation of a product idea. Beginning in block 305 of FIG. 3A, a description of a selected product idea is displayed in a Web page of the social media Web site at the request of a member of the social media Web site. In block 310, a vote of the member is then received in the Web page which may range from a simple “Yes” or “No”, to a weighted value based upon an assigned value from a range of values indicating a degree of interest in the product idea.

In block 315, the voted is weighted. For instance, the vote is further weighted based a reputation of the member casting the vote in terms of the number of votes previously cast by the member, or the number of votes previously cast by a member for product ideas subsequently submitted to the crowd sourced funding engine. As another alternative, the vote is weighted inversely in relationship to a lapse of time from the submission of the product idea to the receipt of the vote. Specifically, the shorter elapsed time results in a more significant weighting whereas a longer elapsed time results in a less significant weighting. Finally, in block 320, the weighted vote is saved in connection with the product idea. As will be understood, the process shown in connection with FIG. 3A may be repeated continuously for different members of the social media Web site and for different product ideas in the list of submitted product ideas.

Turning now to FIG. 3B, the product ideal list is periodically loaded in block 330 for processing. First, in block 335, a record in the list is retrieved for a particular product idea and in block 340, a weighted vote count is computed as a sum of all weighted votes cast for the product idea. In decision block 345, it is determined whether or not the sum exceeds a threshold value. If so, in block 350 the product idea is submitted to the crowd sourced funding engine and in block 360 the record is removed from the list. If not, in decision block 355 it is determined whether or not the product idea has exceeded a permissible time to receive votes in the social media Web site. If so, again the record is removed from the list in block 360. In either circumstance, in decision block 365 it is determined if additional records in the list remain to be processed. If so, the process repeats in block 335. Otherwise, the process ends in block 370.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for social media driven evaluation of a product idea comprising:
providing access to social media Web site served by a Web server over a computer communications network to different members of the social media Web site;
distributing from the Web server over the computer communications network to requesting ones of the different members, a submission form of the social media Web site, the form comprising different text input fields receiving descriptive text regarding a product idea;
receiving from each of the requesting ones of the members in the Web site, a completed form with descriptive text for respectively different product ideas;
storing a record in a database coupled to the Web server for each of the different product ideas and generating a list of the product ideas based upon each stored record;
displaying the list in the social media Web site for viewing by the different members and receiving from a selection of the different members a multiplicity of votes for each of the product ideas in the list; and,
submitting to a crowd sourced funding engine only a selection of ones of the product ideas receiving a threshold number of votes over a fixed period of time.

2. The method of claim 1, wherein each vote comprises a rating and wherein a score is computed for each of the different product ideas as a sum of ratings for received votes and only ones of the product ideas receiving a threshold score over a fixed period of time are submitted to the crowd sourced funding engine of the Web site.

3. The method of claim 1, wherein each vote received for a corresponding one of the product ideas is weighted inversely in relationship to a lapse of time between when each vote is received and when a corresponding one of the forms for a corresponding one of the product ideas is submitted to the Web site.

4. The method of claim 1, wherein each vote received for a corresponding one of the product ideas is weighted in respect to a recorded reputation of a corresponding one of the selection of the different members providing the received vote.

5. The method of claim 4, wherein the recorded reputation is a value computed based upon a number of votes previously cast by the corresponding one of the selection of the different members for others of the product ideas.

6. The method of claim 4, wherein the recorded reputation is a value computed based upon a number of votes previously cast by the corresponding one of the selection of the different members for others of the product ideas submitted to the crowd sourced funding engine of the Web site.

7. A social media data processing system configured for social media driven evaluation of a product idea, the system comprising:
a host computing system comprising one or more computers each with memory and at least one processor;
a Web server executing in the host computing system and serving different Web pages defining a social media Web site for access by different members, the Web site comprising at least one submission form for service to requesting ones of the members of the social media Web site, the form specifying a product idea through different text input fields receiving descriptive text regarding a product idea; and,
a crowd sourced funding engine coupled to the Web site; and,
a product idea evaluation module coupled to the Web server, the module comprising program code enabled upon execution in the host computing system to process completed submission forms respectively including descriptive text for correspondingly different product ideas, to store a record in a database of the host computing system for each of the different product ideas and to generate a list of the different product ideas based upon each stored record, to direct a display by the Web server of the list in the social media Web site for viewing by the different members, to receive from a selection of the different members a multiplicity of votes for each of the product ideas in the list and to submit to the crowd sourced funding engine only ones of the product ideas receiving a threshold number of votes over a fixed period of time.

8. The system of claim 7, wherein each vote comprises a rating and wherein a score is computed for each of the different product ideas as a sum of ratings for received votes and only ones of the product ideas receiving a threshold score over a fixed period of time are submitted to the crowd sourced funding engine of the Web site.

9. The system of claim 7, wherein each vote received for a corresponding one of the product ideas is weighted inversely in relationship to a lapse of time between when each vote is received and when a corresponding one of the forms for a corresponding one of the product ideas is submitted to the Web site.

10. The system of claim 7, wherein each vote received for a corresponding one of the product ideas is weighted in respect to a recorded reputation of a corresponding one of the selection of the different members providing the received vote.

11. The system of claim 10, wherein the recorded reputation is a value computed based upon a number of votes previously cast by the corresponding one of the selection of the different members for others of the product ideas.

12. The system of claim 10, wherein the recorded reputation is a value computed based upon a number of votes previously cast by the corresponding one of the selection of the different members for others of the product ideas submitted to the crowd sourced funding engine of the Web site.

13. A computer program product for social media driven evaluation of a product idea, the computer program product comprising a computer readable storage medium having program instructions embodied therewith, the program instructions executable by a device to cause the device to perform a method comprising:
providing access to social media Web site served by a Web server over a computer communications network to different members of the social media Web site;
distributing from the Web server over the computer communications network to requesting ones of the different members, a submission form of the social media Web site, the form comprising different text input fields receiving descriptive text regarding a product idea;
receiving from each of the requesting ones of the members in the Web site, a completed form with descriptive text for respectively different product ideas;
storing a record in a database coupled to the Web server for each of the different product ideas and generating a list of the product ideas based upon each stored record;
displaying the list in the social media Web site for viewing by the different members and receiving from a selection of the different members a multiplicity of votes for each of the product ideas in the list; and,
submitting to a crowd sourced funding engine of the Web site only a selection of ones of the product ideas receiving a threshold number of votes over a fixed period of time.

14. The computer program product of claim 13, wherein each vote comprises a rating and wherein a score is computed for each of the different product ideas as a sum of ratings for received votes and only ones of the product ideas receiving a threshold score over a fixed period of time are submitted to the crowd sourced funding engine of the Web site.

15. The computer program product of claim 13, wherein each vote received for a corresponding one of the product ideas is weighted inversely in relationship to a lapse of time between when each vote is received and when a corresponding one of the forms for a corresponding one of the product ideas is submitted to the Web site.

16. The computer program product of claim 13, wherein each vote received for a corresponding one of the product ideas is weighted in respect to a recorded reputation of a corresponding one of the selection of the different members providing the received vote.

17. The computer program product of claim 16, wherein the recorded reputation is a value computed based upon a number of votes previously cast by the corresponding one of selection of the different the members for others of the product ideas.

18. The computer program product of claim 16, wherein the recorded reputation is a value computed based upon a number of votes previously cast by the corresponding one of the selection of the different members for others of the product ideas submitted to the crowd sourced funding engine of the Web site.
